(19) United States
(12) Patent Application Publication
(10) Pub. No.: US 2016/0252650 A1
(43) Pub. Date: Sep. 1, 2016

(54) METHOD AND SYSTEM FOR RENDERING VISIBLE A PLUME OF DISPERSING FLUID SO AS TO REVEAL ITS SOURCE

(71) Applicant: SHELL OIL COMPANY, Houston, TX (US)

(72) Inventor: William Joseph HIRST, SR., Rijswijk (NL)

(21) Appl. No.: 15/027,949

(22) PCT Filed: Oct. 7, 2014
(86) PCT No.: PCT/EP2014/071396

§ 371 Date: Apr. 7, 2016

(30) Foreign Application Priority Data
Oct. 9, 2013 (EP) 13187853.0

(51) Int. Cl. G01V 9/00; G01M 3/38; H04N 7/18; G01N 21/64

(52) U.S. Cl. CPC G01V 9/007; G01N 21/6456; G01M 3/38; H04N 7/18

(57) ABSTRACT

A method for monitoring a fluid release plume emitted by an industrial plant and/or an underground hydrocarbon fluid deposit into an adjacent space comprises:
a) monitoring the space by means of a video camera during a selected period of time to generate an input video movie of the space;
b) decomposing the generated input video movie into a series (s) of different spatial frequency bands;
c) filtering the series (s) of spatial frequency bands by means of at least one temporal filter;
d) amplifying the series (s) of filtered spatial frequency bands by a series of selected amplification factors (α₁, α₂, . . . −αₛ), wherein at least one amplification factor (α₁) differs from the other amplification factors (α₂, . . . −αₛ); and
e) reconstructing an output video movie of the space in which the fluid release plume is enhanced by displaying a recomposition of the series of amplified filtered spatial frequency bands.

### BACKGROUND OF THE INVENTION

The invention relates to a method and system for rendering visible and thereby detecting and locating the source of a plume of dispersing fluid as it travels into a distinguishably different fluid.

When used in this specification and claims the term distinguishably different fluid means: by virtue of chemical composition, concentration, temperature or other physical property dependent on such characterizations, such as, but not limited to, refractive index or fluorescent properties.

Established approaches to detecting by rendering visible fluid transport plumes are known from U.S. Pat. No. 6,895,335 and Australian patent AU200926289 and typically involve substantial, specialist imaging systems exploiting spectroscopic absorption features of the fluid species of interest. Such systems typically require a background source of thermal infra-red illumination to reveal the species of interest via absorption of some portion of that radiation by the intervening species of interest. An alternative approach is to employ a very high intensity source of well defined wavelength (such as a laser beam) which is periodically tuned to an absorption frequency of the fluid and then to a reference frequency that is not absorbed. The illuminating beam requires some background object to act as a scattering screen, from which some portion of the illumination is returned to the measuring system. By detecting the ratio of absorbed to non-absorbed wavelengths, a measure of the concentration of the species of interest along the beam path can be obtained and an informative image constructed from those data. Both such approaches, and the many variants that exist of them, are extremely expensive and awkward to apply to the diversity of industrial situations in which one would wish to detect plumes of dispersing fluid emissions. In particular they are ineffective when suitable backgrounds are unavailable—such as for elevated plant structures viewed from the ground and which necessarily have sky as their background. In some systems this limitation can be partially alleviated by using more exotic spectroscopic techniques, which entail even greater optical complexity and costs, such as cryogenic cooling of special long-wave infra-red sensors.

As a consequence of the expense and complexity of the systems described above, most industrial plant such as refineries, chemical plants and associated pipelines, are still inspected using a laborious point-wise search of their pipes, valves, flanges and other seals using hand-held flame-ionisation or photo-ionisation detectors. For a large oil-refinery this can cost in the region of a million US dollar per year to conduct. Inaccessible regions are under-inspected and the measured quantify—concentration—is not directly indicative of the rate of leakage.

In accordance with the invention there is provided a method to render visible the plumes resulting from leaks by adapting the methods disclosed in two recently published related scientific papers.

The first related scientific paper is “Motion Magnification” published by Ce Lui et al of the Computer Science and Artificial Intelligence Lab (CSAIL) of the Massachusetts Institute of Technology (MIT) which presents a technique, motion magnification, that reveals motions that would otherwise be invisible or very difficult to see. The input is a sequence of images from a stationary camera. The system automatically segments a reference frame into regions of “common fate”, grouped by proximity, similar color, and correlated motions. Analogous to focusing a microscope, the user identifies the segment to modify, and specifies the motion magnification factor. The video sequence is then re-rendered with the motions of the selected layer magnified as desired. The output sequence allows the user to see the form and characteristics of the magnified motions in an intuitive display, as if the physical movements themselves had been magnified, then recorded.

The second related scientific paper is “Eulerian Video Magnification for revealing subtle changes in the world” by Hoa-Yu Wu et al of MIT CSAIL and Quanta Research Cambridge Inc. This paper describes a video magnification technique which reveals temporal variations in videos that are difficult or impossible to see with the naked eye and displays them in an indicative manner. The method, called Eulerian Video Magnification, takes a standard video sequence as input, and applies spatial decomposition, followed by temporal filtering to the frames. The resulting signal is then amplified to reveal hidden information.

The Eulerian Video Magnification method can render discernible the periodic changes in colour accompanying changes in the flow of blood as it fills the face and also amplify and render directly visible small—otherwise imperceptible—physical motions. The Eulerian Video Magnification method can run in real time to show phenomena occurring at temporal frequencies selected by the user.

The above described scientific papers indicate that the Motion Magnification and Eulerian Video Magnification methods can be applied for domestic and medical applications and do not describe any configuration whereby the methods are configured to monitor fluid release plumes emitted by a hydrocarbon fluid processing plant and/or render visible natural seepages of hydrocarbon fluids from an underground hydrocarbon fluid deposit into a space or medium adjacent to the plant and/or deposit.

There is a need for an improved robust method and system that facilitate detection of a fluid release plume emitted by a hydrocarbon fluid processing plant and/or an underground hydrocarbon fluid deposit into a space adjacent to the plant and/or deposit in a cost effective and reliable manner.

### SUMMARY OF THE INVENTION

In accordance with the invention there is provided a method for rendering visible a fluid release plume emitted by an industrial facility and/or an underground hydrocarbon fluid deposit into a space adjacent to the plant and/or deposit, the method comprising:
a) imaging the space by means of a video camera during a selected period of time to generate an input video movie of the space;
b) decomposing the generated input video movie into a series (s) of different spatial frequency bands;
c) filtering the series (s) of spatial frequency bands by means of at least one temporal filter;
d) amplifying the series (s) of filtered spatial frequency bands by a series of selected amplification factors (α₁, α₂, . . . −αₛ), wherein at least one amplification factor (α₁) differs from the other amplification factors (α₂, . . . −αₛ); and
e) reconstructing an output video movie of the space in which the fluid release plume is enhanced by displaying a recomposition of the series of amplified filtered spatial frequency bands.

Steps b-e may comprise a differentiated spatial frequency band amplification technique which is known as an eulerian video magnification technique and the method may be configured to enhance fluid motions in the plume, for example by enhancing the visibility of refractive index changes within the plume.

The space may be a region of the atmosphere, which region is located in the vicinity of, and at least partially includes, a hydrocarbon fluid processing plant formed by an onshore or offshore crude oil and/or natural gas production facility, an oil refinery, a natural gas distribution facility, a pipeline, or a chemical plant in which a hydrocarbon fluid containing feedstock is converted into a marketable chemical product and the method may utilize a video movie generated by at least one surveillance camera to monitor the fluid release plume, which is generated by leakage of hydrocarbon fluid processing, storage and/or transportation equipment of the plant and the method comprises generating an alarm signal to plant operating staff in case a fluid release plume exceeds a selected size or composition.

For enhancing the visibility of hydrocarbon fluid seeps from the plant or formation into the adjoining space, the space may be illuminated by a modulated source of light that produces fluorescence of the hydrocarbon fluid. The effect of this fluorescence will be to modulate the observed fluid plume's colour slightly, which colour change may be magnified by an Eulerian Video Magnification scheme as known from the scientific paper “Eulerian Video Magnification for revealing subtle changes in the world” by Hoa-Yu Wu et al of MIT CSAIL and Quanta Research Cambridge Inc.

Alternatively, the space may be a region of the atmosphere or a body of water, which region is located in the vicinity of, and at least partially includes, an underground hydrocarbon fluid deposit formed by a crude oil and/or natural gas containing formation, in which case the method may utilize a video movie generated by at least one video camera to monitor leakage of the fluid release plume, which is generated by emission of natural gas or natural gas containing fluids into the atmosphere or the body of water.

In accordance with the invention there is also provided a system for monitoring a fluid release plume emitted by a hydrocarbon fluid processing plant and/or an underground hydrocarbon fluid deposit into a space adjacent to the plant and/or deposit, the system comprising:
a) a video camera for monitoring the space during a selected period of time to generate an input video movie of the space;
b) means for decomposing the generated input video movie into a series (s) of different spatial frequency bands;
c) at least one temporal filter for filtering the series (s) of spatial frequency bands;
d) a series of amplifiers for amplifying the series (s) of filtered spatial frequency bands by a series of selected amplification factors (α₁, α₂, . . . −αₛ), wherein at least one amplification factor (α₁) differs from the other amplification factors (α₂, . . . −αₛ); and
e) a display for displaying an output video movie of the space in which the fluid release plume is enhanced by a recomposition of the series of amplified filtered spatial frequency bands.

These and other features, embodiments and advantages of the method and system according to the invention are described in the accompanying claims, abstract and the following detailed description of non-limiting embodiments depicted in the accompanying drawing. Objects and other features depicted in the figure and/or described in this specification, abstract and/or claims may be combined in different ways by a person skilled in the art.

### BRIEF DESCRIPTION OF THE DRAWING

FIG. 1 depicts a fluid release plume of which the visibility is enhanced by the method according to the invention.

### DETAILED DESCRIPTION OF THE DEPICTED EMBODIMENT

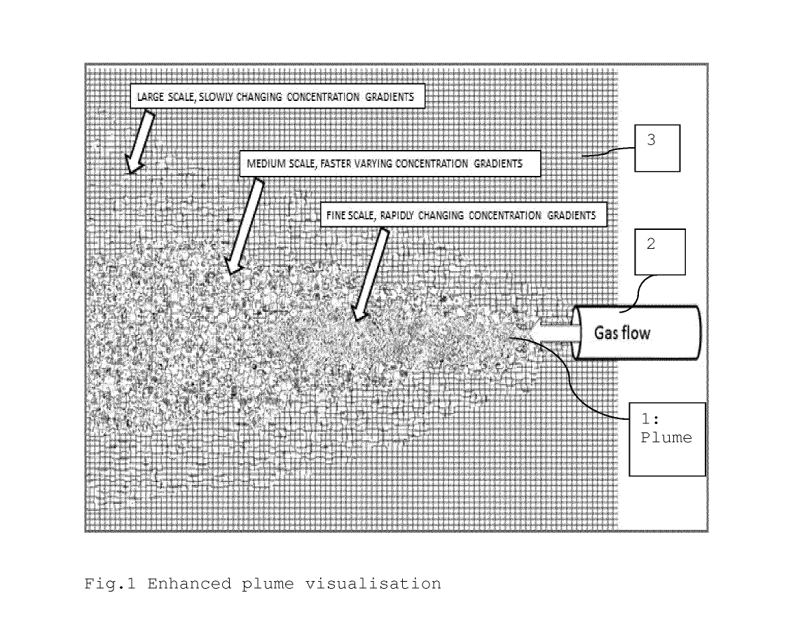

FIG. 1 shows a fluid release plume 1 emitted by a gas flow emission source 2, such as a gas nozzle or a leaking gas storage vessel or pipeline, or an exhaust pipe of a gas combustion device of which the visibility is enhanced by the method according to the invention so that the plume 1 is better visible to the human eye.

FIG. 1 further illustrates the effect that changes in gas concentration and/or temperature within a dispersing plume 1 have on a scene viewed through that plume 1.

The locations of scene elements are chaotically deviated by amounts determined by the refractive index changes associated with changes in fluid concentration and temperature within the plume 1. The timescales of those deviations reflect the timescales of the mixing process within the plume 1. Such effects have previously been exploited in optical Schlieren systems, but their direct computation from a conventional moving image recording is a novel approach to gas and/or fluid flow detection, location and visualization within a plume 1.

The plume display enhancement technique shown in FIG. 1 employs a differentiated spatial frequency band amplification technique which is known as an eulerian video magnification technique and is used to enhance fluid motions in the plume 1 thereby enhancing the visibility of refractive index changes within the plume 1.

In the eulerian video magnification technique according to the invention the fluid release plume 1 is enhanced by displaying a recomposition of the series of amplified filtered spatial frequency bands, wherein
a) the space 3 is monitored by means of a conventional video surveillance camera during a selected period of time to generate an input video movie of the space 3;
b) the generated input video movie is decomposed into a series (s) of different spatial frequency bands;
c) the series (s) of spatial frequency bands is filtered by means of at least one temporal filter;
d) the series (s) of filtered spatial frequency bands is amplified by a series of selected amplification factors (α1, α2, . . . −αs), wherein at least one amplification factor (α1) differs from the other amplification factors (α2, . . . −αs); and
e) an output video movie is reconstructed of the space 3 in which the fluid release plume 1 is enhanced by displaying a recomposition of the series of amplified filtered spatial frequency bands, of which a screenshot is shown in FIG. 1.

The space 3 surrounding the plume 1 may be a region of the atmosphere in the vicinity of onshore or offshore crude oil and/or natural gas production facility, an oil refinery, a natural gas distribution facility, a pipeline, or a chemical plant in which a hydrocarbon fluid containing feedstock is converted into a marketable chemical product and the method may utilize a video movie generated by at least one surveillance camera to monitor the fluid release plume, which is generated by leakage of hydrocarbon fluid processing, storage and/or transportation equipment of the plant where an alarm signal is transmitted to plant operating staff in case a fluid release plume 1 exceeds a selected size or composition.

To further enhance the visibility of hydrocarbon fluid plumes 1 from a plant or formation into the atmosphere, the space 3 may be illuminated by a modulated source of light that produces fluorescence of the hydrocarbon fluid plume 1. The effect of this fluorescence will be to modulate the observed fluid plume's colour slightly, which colour change may be magnified by an Eulerian Video Magnification scheme as known from the scientific paper “Eulerian Video Magnification for revealing subtle changes in the world” by Hoa-Yu Wu et al of MIT CSAIL and Quanta Research Cambridge Inc.

Therefore, the method according to present invention is well adapted to attain the ends and advantages mentioned as well as those that are inherent therein.

The particular embodiment disclosed above is illustrative only, as the present invention may be modified, combined and/or practiced in different but equivalent manners apparent to those skilled in the art having the benefit of the teachings herein.

Furthermore, no limitations are intended to the details of construction or design herein shown, other than as described in the claims below.

It is therefore evident that the particular illustrative embodiments disclosed above may be altered, combined and/or modified and all such variations are considered within the scope of the present invention as defined in the accompanying claims.

While any methods, systems and/or products embodying the invention are described in terms of “comprising,” “containing,” or “including” various described features and/or steps, they can also “consist essentially of” or “consist of” the various described features and steps.

All features and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values.

Also, the terms in the claims have their plain, ordinary meaning unless otherwise explicitly and clearly defined by the patentee.

Moreover, the indefinite articles “a” or “an”, as used in the claims, are defined herein to mean one or more than one of the element that it introduces.

If there is any conflict in the usages of a word or term in this specification and one or more patent or other documents that may be cited herein by reference, the definitions that are consistent with this specification should be adopted.

1. A method for rendering visible a fluid release plume emitted by an industrial plant and/or an underground hydrocarbon fluid deposit into a space adjacent to the plant and/or deposit, the method comprising:
a) imaging the space by means of a video camera during a selected period of time to generate an input video movie of the space;
b) decomposing the generated input video movie into a series (s) of different spatial frequency bands;
c) filtering the series (s) of spatial frequency bands by means of at least one temporal filter;
d) amplifying the series (s) of filtered spatial frequency bands by a series of selected amplification factors (α₁, α₂, . . . −αₛ), wherein at least one amplification factor (α₁) differs from the other amplification factors (α₂, . . . −aₛ); and
e) reconstructing an output video movie of the space in which the fluid release plume is enhanced by displaying a recomposition of the series of amplified filtered spatial frequency bands.

2. The method of claim 1, wherein steps b-e comprise a differentiated spatial frequency band amplification technique which is known as an eulerian video magnification technique.

3. The method of claim 1, wherein the method is configured to enhance fluid motions in the plume.

4. The method of claim 1, wherein the method is configured to enhance the visibility of refractive index changes within the plume.

5. The method of claim 4, wherein the plume comprises hydrocarbon fluid and the space is illuminated by a modulated light source that produces fluorescence of the hydrocarbon fluid, which fluorescence modulates the plume's color and the thereby generated color change is enhanced by an eulerian video magnification technique.

6. The method of claim 1, wherein the space is a region of the atmosphere, which region is located in the vicinity of, and at least partially includes, a hydrocarbon fluid processing plant formed by an onshore or offshore crude oil and/or natural gas production facility, a hydrocarbon fluid transportation pipeline, an oil refinery, a natural gas distribution facility or a chemical plant in which a hydrocarbon fluid containing feedstock is converted into a marketable chemical product.

7. The method of claim 6, wherein the method uses a video movie generated by at least one plant surveillance camera to monitor the fluid release plume, which is generated by leakage of hydrocarbon fluid processing, storage and/or transportation equipment of the plant and the method comprises generating an alarm signal to plant operating staff in case a fluid release plume exceeds a selected size or composition.

8. The method of claim 1, wherein the space is a region of the atmosphere or a body of water, which region is located in the vicinity of, and at least partially includes, an underground hydrocarbon fluid deposit formed by a crude oil and/or natural gas containing formation.

9. The method of claim 8, wherein the method uses a video movie generated by at least one video camera to monitor leakage of the fluid release plume, which is generated by emission of natural gas or natural gas containing fluids into the atmosphere or the body of water.

10. The method of claim 9, wherein the space is located underwater and the camera is an underwater video camera.

11. A system for monitoring a fluid release plume emitted by an industrial plant and/or an underground hydrocarbon fluid deposit into a space adjacent to the plant and/or deposit, the system comprising:
a) a video camera for monitoring the space during a selected period of time to generate an input video movie of the space;
b) means for decomposing the generated input video movie into a series (s) of different spatial frequency bands;
c) at least one temporal filter for filtering the series (s) of spatial frequency bands;
d) a series of amplifiers for amplifying the series (s) of filtered spatial frequency bands by a series of selected amplification factors (α₁, α₂, . . . −αₛ), wherein at least one amplification factor (α₁) differs from the other amplification factors (α₂, . . . −αₛ); and
e) a display for displaying an output video movie of the space in which the fluid release plume is enhanced by a recomposition of the series of amplified filtered spatial frequency bands.

12. The system according to claim 10, wherein steps b-e comprise a differentiated spatial frequency band amplification technique which is known as an eulerian video magnification technique which enhances fluid motions in the plume.

13. The system of claim 12, wherein the plume comprises hydrocarbon fluid and the system comprises a modulated light source that illuminates the space such that it produces fluorescence of the hydrocarbon fluid, which fluorescence modulates the plume's color and the thereby generated color change is enhanced by an eulerian video magnification technique.
